(19) United States
(12) Patent Application Publication
(10) Pub. No.: US 2023/0182758 A1
(43) Pub. Date: Jun. 15, 2023

(54) DISPLAY CONTROL DEVICE, VEHICLE DISPLAY DEVICE, VEHICLE, DISPLAY CONTROL METHOD, AND NON-TRANSITORY STORAGE MEDIUM

(71) Applicant: TOYOTA JIDOSHA KABUSHIKI KAISHA, Toyota-shi (JP)

(72) Inventor: Takuma YAMADA, Toyota-shi (JP)

(21) Appl. No.: 17/937,557

(22) Filed: Oct. 3, 2022

(30) Foreign Application Priority Data
Dec. 9, 2021 (JP) 2021-200118

(51) Int. Cl. B60W 50/12; B60K 35/00; B60W 50/14

(52) U.S. Cl. CPC B60W 50/12; B60K 35/00; B60W 50/14; B60K 2370/1876; B60K 2370/162; B60K 2370/52; B60K 2370/48; B60Y 2400/3032; B60W 2050/146; B60W 2520/28

(57) ABSTRACT

A display control device for a vehicle includes a processor. The processor is configured to switch permission or forbiddance of execution of target control for a predetermined function by an operation of an occupant, acquire a permission status indicating permission or forbiddance of the execution of the target control, recognize a condition of the vehicle, determine whether to propose a first operation or a second operation to the occupant based on the permission status and the condition of the vehicle, and display first information related to the first operation on a display unit provided in the vehicle when the processor determines to propose the first operation to the occupant, or display second information related to the second operation on the display unit when the processor determines to propose the second operation to the occupant.

### CROSS-REFERENCE TO RELATED APPLICATION

This application claims priority to Japanese Patent Application No. 2021-200118 filed on Dec. 9, 2021, incorporated herein by reference in its entirety.

### BACKGROUND

### 1. Technical Field

The present disclosure relates to a display control device, a vehicle display device, a vehicle, a display control method, and a non-transitory storage medium.

### 2. Description of Related Art

There is known a vehicle switch control device that notifies an occupant about an abnormality in a traction control system when a traction control operation signal is continuously input for a certain period or longer (for example, Japanese Unexamined Patent Application Publication No. 2000-313289 (JP 2000-313289 A)).

### SUMMARY

In a vehicle configured such that permission or forbiddance of execution of target control for a predetermined function is switchable by an operation of an occupant, there is a possibility that the occupant does not voluntarily perform the operation of switching the permission or forbiddance of the execution of the target control depending on the situation of the vehicle.

In view of the above, the present disclosure provides a display control device, a vehicle display device, a vehicle, a display control method, and a non-transitory storage medium that can prompt an occupant to perform an operation of switching permission or forbiddance of execution of target control depending on a situation of the vehicle.

A display control device for a vehicle according to a first aspect of the present disclosure includes a processor. The processor is configured to switch permission or forbiddance of execution of target control for a predetermined function by an operation of an occupant. The processor is configured to acquire a permission status indicating permission or forbiddance of the execution of the target control. The processor is configured to recognize a condition of the vehicle based on a detection result from an internal sensor configured to detect the condition of the vehicle. The processor is configured to determine whether to propose a first operation or a second operation to the occupant based on the permission status and the condition of the vehicle. The first operation is an operation for forbidding the execution of the target control in which the permission status indicates permission. The second operation is an operation for permitting the execution of the target control in which the permission status indicates forbiddance. The processor is configured to display first information related to the first operation on a display unit provided in the vehicle when the processor determines to propose the first operation to the occupant, or display second information related to the second operation on the display unit when the processor determines to propose the second operation to the occupant.

In the display control device according to the first aspect of the present disclosure, the processor determines whether to propose, to the occupant, the first operation for forbidding the execution of the target control in which the permission status indicates permission based on the permission status indicating permission or forbiddance of the execution of the target control and the condition of the vehicle. When determination is made to propose the first operation to the occupant, the processor displays the first information related to the first operation on the display unit. Alternatively, the processor determines whether to propose, to the occupant, the second operation for permitting the execution of the target control in which the permission status indicates forbiddance based on the permission status and the condition of the vehicle. When determination is made to propose the second operation to the occupant, the processor displays the second information related to the second operation on the display unit. Therefore, the occupant can easily recognize options for permission or forbiddance of the execution of the target control depending on the situation of the vehicle. Thus, it is possible to prompt the occupant to perform the operation of switching the permission or forbiddance of the execution of the target control depending on the situation of the vehicle.

In the display control device according to the first aspect of the present disclosure, the target control may include first control in which the permission status is automatically set to permission when the vehicle is powered ON. The processor may be configured to determine whether to propose the first operation for the first control to the occupant. The processor may be configured to display the first information on the first control on the display unit when the processor determines to propose the first operation to the occupant. In this case, it is possible to prompt, depending on the situation of the vehicle, the occupant to perform the first operation for forbidding the execution of the first control in which the permission status is automatically set to permission when the vehicle is powered ON.

In the display control device according to the first aspect of the present disclosure, the target control may include second control in which the permission status is automatically set to forbiddance when the vehicle is powered ON. The processor may be configured to determine whether to propose the second operation for the second control to the occupant. The processor may be configured to display the second information on the second control on the display unit when the processor determines to propose the second operation to the occupant. In this case, it is possible to prompt, depending on the situation of the vehicle, the occupant to perform the second operation for permitting the execution of the second control in which the permission status is automatically set to forbiddance when the vehicle is powered ON.

In the display control device according to the first aspect of the present disclosure, the processor may be configured to determine to propose the second operation to the occupant when a predetermined period has elapsed since the execution of the target control was forbidden in response to the first operation. In this case, it is possible to prompt the occupant to return the execution of the first control forbidden in response to the first operation to permission through the second operation depending on the situation of the vehicle.

In the display control device according to the first aspect of the present disclosure, the target control may be traction control. The internal sensor may include a driving wheel speed sensor configured to detect a driving wheel speed of a driving wheel. The processor may be configured to determine to propose the first operation for the traction control to the occupant when an idling condition related to the traction control is satisfied based on a detection result from the driving wheel speed sensor. The processor may be configured to display the first information on the traction control on the display unit when the processor determines to propose the first operation to the occupant. The situation of the vehicle varies broadly. Therefore, even if the idling condition is satisfied, there is a possibility that the execution of the traction control is not always appropriate for the situation of the vehicle. Therefore, it is possible to prompt the occupant to perform the first operation for forbidding the execution of the traction control depending on the situation of the vehicle.

In the display control device according to the first aspect of the present disclosure, the internal sensor may include a rolling wheel speed sensor configured to detect a rolling wheel speed of a rolling wheel, and an accelerator sensor configured to detect an accelerator operation amount. The processor may be configured to determine to propose the first operation for the traction control to the occupant when the rolling wheel speed is equal to or lower than a predetermined rolling wheel speed threshold and the accelerator operation amount is equal to or larger than a predetermined operation amount threshold. In this case, there is a possibility that both right and left driving wheels easily idle in an attempt to escape from a stuck condition such as a snowy road. Therefore, it is possible to prompt the occupant to perform the first operation for forbidding the execution of the traction control depending on the situation of the vehicle.

In the display control device according to the first aspect of the present disclosure, the driving wheel speed sensor may be configured to detect the driving wheel speeds of the driving wheels on right and left. The processor may be configured to determine not to propose the first operation to the occupant when a right-and-left ratio of the driving wheel speeds is higher than a predetermined right-and-left ratio threshold. In this case, for example, one of the right and left driving wheels is idling, and there is a possibility that the execution of the traction control is appropriate for the situation of the vehicle. Therefore, it is possible to avoid, depending on the situation of the vehicle, the proposal to the occupant about the first operation for forbidding the execution of the traction control.

In the display control device according to the first aspect of the present disclosure, the processor may be configured to determine to propose the second operation to the occupant when execution of the traction control is forbidden in response to the first operation and the idling condition is not satisfied continuously for a predetermined period. In this case, for example, there is a possibility that the occupant has forbidden the execution of the traction control by a voluntary operation and then forgets to return the permission status to permit the execution of the traction control. Therefore, it is possible to prompt the occupant to return the execution of the traction control to permission through the second operation.

A vehicle display device may include the display control device according to the first aspect of the present disclosure, and the display unit to be controlled by the display control device.

A vehicle may include the vehicle display device according to the first aspect of the present disclosure.

A display control method for controlling a display unit provided in a vehicle according to a second aspect of the present disclosure includes switching permission or forbiddance of execution of target control for a predetermined function by an operation of an occupant, acquiring a permission status indicating permission or forbiddance of the execution of the target control, recognizing a condition of the vehicle based on a detection result from an internal sensor configured to detect the condition of the vehicle, determining whether to propose a first operation or a second operation to the occupant based on the permission status and the condition of the vehicle, and displaying first information related to the first operation on the display unit when determination is made to propose the first operation to the occupant, or displaying second information related to the second operation on the display unit when determination is made to propose the second operation to the occupant. The first operation is an operation for forbidding the execution of the target control in which the permission status indicates permission. The second operation is an operation for permitting the execution of the target control in which the permission status indicates forbiddance.

In the display control method according to the second aspect of the present disclosure, determination is made as to whether to propose, to the occupant, the first operation for forbidding the execution of the target control in which the permission status indicates permission based on the permission status indicating permission or forbiddance of the execution of the target control and the condition of the vehicle. When determination is made to propose the first operation to the occupant, the first information related to the first operation is displayed on the display unit. Alternatively, determination is made as to whether to propose, to the occupant, the second operation for permitting the execution of the target control in which the permission status indicates forbiddance based on the permission status and the condition of the vehicle. When determination is made to propose the second operation to the occupant, the second information related to the second operation is displayed on the display unit. Therefore, the occupant can easily recognize options for permission or forbiddance of the execution of the target control depending on the situation of the vehicle. Thus, it is possible to prompt the occupant to perform the operation of switching the permission or forbiddance of the execution of the target control depending on the situation of the vehicle.

A non-transitory storage medium according to a third aspect of the present disclosure stores instructions that are executable by one or more processors of a display control device configured to control a display unit provided in a vehicle and that cause the one or more processors to perform functions. The functions include switching permission or forbiddance of execution of target control for a predetermined function by an operation of an occupant, acquiring a permission status indicating permission or forbiddance of the execution of the target control, recognizing a condition of the vehicle based on a detection result from an internal sensor configured to detect the condition of the vehicle, determining whether to propose a first operation or a second operation to the occupant based on the permission status and the condition of the vehicle, and displaying first information related to the first operation on the display unit when determination is made to propose the first operation to the occupant, or displaying second information related to the second operation on the display unit when determination is made to propose the second operation to the occupant. The first operation is an operation for forbidding the execution of the target control in which the permission status indicates permission. The second operation is an operation for permitting the execution of the target control in which the permission status indicates forbiddance.

In the non-transitory storage medium according to the third aspect of the present disclosure, the processor determines whether to propose, to the occupant, the first operation for forbidding the execution of the target control in which the permission status indicates permission based on the permission status indicating permission or forbiddance of the execution of the target control and the condition of the vehicle. When determination is made to propose the first operation to the occupant, the processor displays the first information related to the first operation on the display unit. Alternatively, the processor determines whether to propose, to the occupant, the second operation for permitting the execution of the target control in which the permission status indicates forbiddance based on the permission status and the condition of the vehicle. When determination is made to propose the second operation to the occupant, the processor displays the second information related to the second operation on the display unit. Therefore, the occupant can easily recognize options for permission or forbiddance of the execution of the target control depending on the situation of the vehicle. Thus, it is possible to prompt the occupant to perform the operation of switching the permission or forbiddance of the execution of the target control depending on the situation of the vehicle.

With various aspects and embodiments of the present disclosure, it is possible to prompt the occupant to perform the operation of switching the permission or forbiddance of the execution of the target control depending on the situation of the vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing schematic configurations of a display control device, a vehicle display device, and a vehicle according to an embodiment;

FIG. 2 is a diagram showing an example of display of first information related to a first operation on a display unit;

FIG. 3 is a diagram showing another example of the display of the first information related to the first operation on the display unit;

FIG. 4 is a flowchart showing an example of a proposal determination process for the first operation;

FIG. 5 is a flowchart showing an example of a display control process for the first information;

FIG. 6 is a flowchart showing another example of the proposal determination process for the first operation;

FIG. 7 is a flowchart showing another example of the display control process for the first information;

FIG. 8 is a flowchart showing an example of a proposal determination process for a second operation;

FIG. 9 is a flowchart showing an example of a display control process for second information;

FIG. 10 is a flowchart showing another example of the proposal determination process for the second operation;

FIG. 11 is a flowchart showing another example of the display control process for the second information;

FIG. 12 is a diagram showing another example of the display of the first information related to the first operation on the display unit;

FIG. 13 is a diagram showing another example of the display of the first information related to the first operation on the display unit; and

FIG. 14 is a flowchart showing another example of the proposal determination process for the second operation.

### DETAILED DESCRIPTION OF EMBODIMENTS

An embodiment of the present disclosure will be described below with reference to the drawings. In the following description, the same or corresponding elements will be denoted by the same reference symbols, and overlapping description will be omitted.

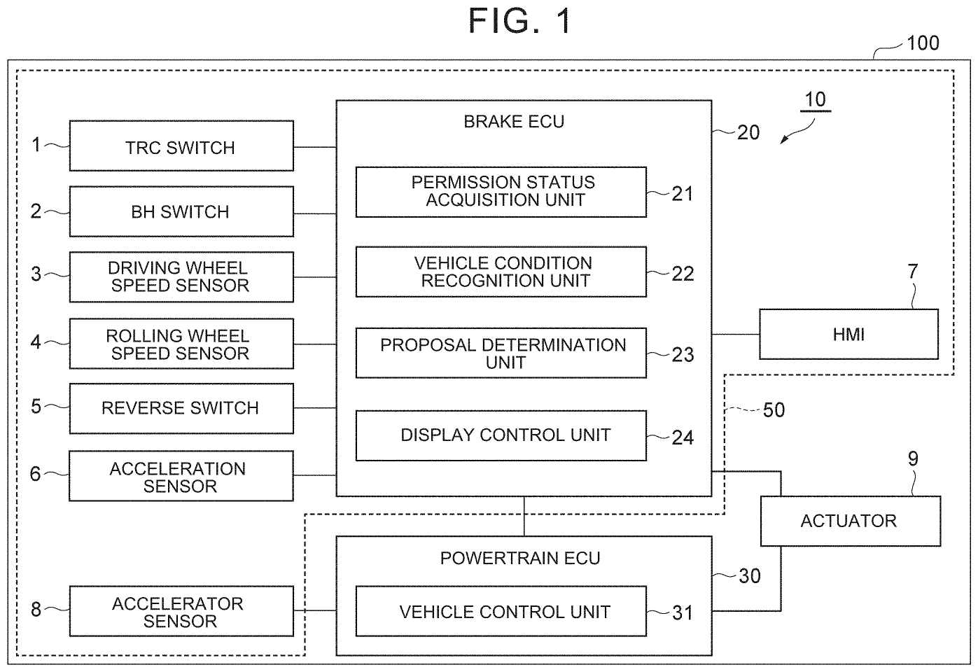

FIG. 1 is a block diagram showing schematic configurations of a display control device, a vehicle display device, and a vehicle according to the embodiment. A vehicle 100 shown in FIG. 1 is not particularly limited, and is, for example, a passenger car. For example, in the vehicle 100, some of a plurality of wheels are driving wheels, and the rest are rolling wheels. The vehicle 100 may be, for example, a front-engine, front-wheel-drive (FF) vehicle in which a right front wheel and a left front wheel are driving wheels and a right rear wheel and a left rear wheel are rolling wheels, or a front-engine, rear-wheel-drive (FR) vehicle in which a right front wheel and a left front wheel are rolling wheels and a right rear wheel and a left rear wheel are driving wheels.

The vehicle 100 includes a brake electronic control unit (ECU) 20 and can execute target control for a predetermined function. In the vehicle 100, permission or forbiddance of the execution of the target control is switchable by an operation of an occupant. The target control means control to be subjected to switching between permission and forbiddance of execution. Examples of the target control include a known traction control system (TRC) and known brake hold (BH).

The predetermined function is a function that can be exerted by the target control. The predetermined function of the traction control includes a function of comparing a driving wheel speed of each driving wheel with an estimated vehicle body speed and, when an idling drive wheel is identified, suppressing the idling of the driving wheel. In the traction control, the idling of the driving wheel is suppressed by, for example, at least one of control for reducing a driving force for rotating the idling drive wheel and control for applying a braking force to the idling drive wheel.

The predetermined function of the brake hold includes a function of keeping the braking force while the vehicle 100 is stopped, for example, waiting at a traffic light. In the brake hold, the keeping of the braking force is started in response to a predetermined operation such as depression of a brake pedal in a certain amount or more, and is terminated in response to a predetermined operation such as depression of an accelerator pedal in a certain amount or more.

The target control includes first control in which the permission status is automatically set to permission when the vehicle 100 is powered ON. Powering ON the vehicle 100 means, for example, turning ON power supply to an electronic control unit group including the brake ECU 20. Examples of the first control include the traction control and the brake hold. The permission status of the first control is automatically set to permission when the vehicle 100 is powered ON, and is maintained as the permission until switching is made to forbiddance by an operation of the occupant. The permission status of the target control may be stored in the brake ECU 20.

As shown in FIG. 1, a display control device 10 includes the brake ECU 20. The brake ECU 20 includes a central processing unit (CPU) (processor), a read only memory (ROM), a random access memory (RAM), a controller area network (CAN) communication circuit, and the like. In the brake ECU 20, for example, a program stored in the ROM is loaded into the RAM, and the program loaded in the RAM is executed by the CPU to control an actuator 9 described later, thereby implementing the predetermined function of the target control. The brake ECU 20 may be composed of a plurality of electronic control units.

The brake ECU 20 is connected to a TRC switch 1, a BH switch 2, a driving wheel speed sensor (internal sensor) 3, a rolling wheel speed sensor (internal sensor) 4, a reverse switch 5, an acceleration sensor (internal sensor) 6, a human-machine interface (HMI) 7, and the actuator 9.

The TRC switch 1 is a hardware switch for switching permission or forbiddance of the execution of the traction control. The TRC switch 1 is arranged so that the TRC switch 1 can be operated by an occupant in a driver's seat of the vehicle 100. The TRC switch 1 transmits, for example, an electric signal indicating permission of the execution of the traction control to the brake ECU 20 when the conduction status (switch status) is ON. The TRC switch 1 transmits an electric signal indicating forbiddance of the execution of the traction control to the brake ECU 20 when the switch status is OFF. That is, the permission or forbiddance of the execution of the traction control is switchable by an operation of the occupant.

The BH switch 2 is a hardware switch for switching permission or forbiddance of the execution of the brake hold. The BH switch 2 is arranged so that the BH switch 2 can be operated by an occupant in the driver's seat of the vehicle 100. The BH switch 2 transmits, for example, an electric signal indicating permission of the execution of the brake hold to the brake ECU 20 when the conduction status (switch status) is ON. The BH switch 2 transmits, for example, an electric signal indicating forbiddance of the execution of the brake hold to the brake ECU 20 when the switch status is OFF. That is, the permission or forbiddance of the execution of the brake hold is switchable by an operation of the occupant.

The driving wheel speed sensor 3 is a detector that detects a driving wheel speed that is a rotation speed of each driving wheel of the vehicle 100. The driving wheel speed sensor 3 includes, for example, a plurality of sensors provided on the right and left driving wheels, respectively. The driving wheel speed sensor 3 detects the driving wheel speeds of the right and left driving wheels. The driving wheel speed sensor 3 is provided, for example, on the driving wheels of the vehicle 100 or drive shafts that rotate together with the driving wheels. A wheel speed sensor that detects the rotation speed of the driving wheel is used as the driving wheel speed sensor 3. The driving wheel speed sensor 3 transmits information on the detected driving wheel speeds to the brake ECU 20.

The rolling wheel speed sensor 4 is a detector that detects a rolling wheel speed that is a rotation speed of each rolling wheel of the vehicle 100. For example, a wheel speed sensor provided for each rolling wheel of the vehicle 100 and configured to detect the rotation speed of the rolling wheel is used as the rolling wheel speed sensor 4. The rolling wheel speed sensor 4 transmits information on the detected rolling wheel speeds to the brake ECU 20.

The reverse switch 5 detects a state in which the traveling direction of the vehicle 100 is a backward direction. The reverse switch 5 is provided, for example, on a shift lever of the vehicle 100 or a transmission of the vehicle 100. The reverse switch 5 transmits an electric signal to the brake ECU 20 when the traveling direction of the vehicle 100 is the backward direction. The electric signal from the reverse switch 5 may be transmitted to the brake ECU 20 via, for example, a shift-by-wire ECU.

The acceleration sensor 6 is a detector that detects an acceleration of the vehicle 100. The acceleration sensor 6 detects at least a longitudinal acceleration of the vehicle 100. The acceleration sensor 6 transmits information on the detected acceleration of the vehicle 100 to the brake ECU 20.

The HMI 7 is an interface for inputting and outputting information between the display control device 10 and the occupant (including a driver). The HMI 7 includes a display (display unit) 7a. The HMI 7 outputs an image on the display 7a in response to a control signal from the brake ECU 20.

The display 7a is a display device that can be viewed by the occupant in the vehicle 100. The display 7a is provided, for example, on a dashboard of the vehicle 100. The display 7a has a display screen for displaying an image for the occupant. The display 7a displays an image on the display screen based on a control signal from the brake ECU 20. The display 7a may include a head-up display (HUD) that projects an image onto a windshield of the vehicle 100 or a projection screen.

The HMI 7 includes a touch panel that receives an input operation from the occupant. The display 7a may be the touch panel. The HMI 7 transmits, to the brake ECU 20, input information indicating that the occupant touches a button image displayed on the touch panel.

The display 7a of the HMI 7 is controlled by the display control device 10. The display 7a of the HMI 7 and the display control device 10 constitute a vehicle display device 50. The vehicle display device 50 is mounted on the vehicle 100. That is, the vehicle 100 includes the vehicle display device 50. The display unit of the vehicle display device 50 need not be mounted on the vehicle. The display unit may be, for example, a screen of a terminal that is not fixed to the vehicle 100 and uses wireless communication.

The brake ECU 20 is connected to a powertrain ECU 30. The powertrain ECU 30 is an electronic control unit that controls a drive source and a drive system of the vehicle 100. The powertrain ECU 30 is connected to an accelerator sensor (internal sensor) 8 and the actuator 9.

The accelerator sensor 8 is a detector that detects an amount of operation on the accelerator pedal by the driver of the vehicle 100 (accelerator operation amount). The accelerator sensor 8 transmits information on the detected accelerator operation amount to the powertrain ECU 30.

The actuator 9 is a device to be used to control the vehicle 100. The actuator 9 includes at least a drive actuator and a brake actuator. The drive actuator controls a driving force of the driving wheels of the vehicle 100 by controlling an amount of air to be supplied to an engine (throttle valve opening degree) in response to a control signal from the powertrain ECU 30. When the vehicle 100 is a hybrid electric vehicle, a control signal from the powertrain ECU 30 is input to a motor serving as a power source to control the driving force of the driving wheels in addition to the amount of air to be supplied to the engine. When the vehicle 100 is a battery electric vehicle, a control signal from the powertrain ECU 30 is input to a motor serving as a power source to control the driving force of the driving wheels. The motor serving as the power source in the cases above constitutes the actuator 9. The brake actuator controls a brake system in response to a control signal from the brake ECU 20 to control a braking force to be applied to the driving wheels and the rolling wheels of the vehicle 100. Examples of the brake system include a hydraulic brake system.

Next, the functional configuration of the brake ECU 20 will be described. The brake ECU 20 includes a permission status acquisition unit 21, a vehicle condition recognition unit 22, a proposal determination unit 23, and a display control unit 24. The functions of the brake ECU 20 may partially be performed on a server communicable with the vehicle 100.

The permission status acquisition unit 21 acquires a permission status indicating permission or forbiddance of the execution of the target control. The permission status acquisition unit 21 acquires, for example, a permission status of the traction control based on the switch status of the TRC switch 1. The permission status acquisition unit 21 may acquire the permission status of the traction control based on a permission status stored in the brake ECU 20. The permission status acquisition unit 21 acquires, for example, a permission status of the brake hold based on the switch status of the BH switch 2. The permission status acquisition unit 21 may acquire the permission status of the brake hold based on a permission status stored in the brake ECU 20.

The vehicle condition recognition unit 22 recognizes (acquires) conditions of the vehicle 100 based on detection results from the internal sensors that detect the conditions of the vehicle 100. The vehicle condition recognition unit 22 acquires, for example, an accelerator operation amount, driving wheel speeds, rolling wheel speeds, and shift position information based on detection results from the accelerator sensor 8, the driving wheel speed sensor 3, the rolling wheel speed sensor 4, and the reverse switch 5.

The proposal determination unit 23 determines whether to propose either a first operation or a second operation to the occupant based on the permission status of the execution of the target control and the conditions of the vehicle 100.

The first operation is an operation to be performed by the occupant to forbid the execution of the target control in which the permission status indicates permission. As a specific example, the first operation includes an operation in which, when the permission status of the traction control indicates permission, the occupant changes the switch status of the TRC switch 1 from ON to OFF in order to forbid the execution of the traction control. The first operation includes an operation in which, when the permission status of the brake hold indicates permission, the occupant changes the switch status of the BH switch 2 from ON to OFF in order to forbid the execution of the brake hold.

The first and second operations may be performed by the occupant via the HMI 7. For example, the occupant may perform the first operation by touching a switch image for the first operation that is displayed on the display 7a of the HMI 7. The occupant may perform the second operation by touching a switch image for the second operation that is displayed on the display 7a of the HMI 7.

The proposal determination unit 23 may determine whether to propose, to the occupant, the first operation for the first control in which the permission status is automatically set to permission when the vehicle 100 is powered ON. In a case where the permission status of the traction control as an example of the first control is automatically set to permission when the vehicle 100 is powered ON, the proposal determination unit 23 may determine whether to propose, to the occupant, the first operation for forbidding the execution of the traction control.

The proposal determination unit 23 may determine to propose the first operation for the traction control to the occupant, for example, when an idling condition is satisfied based on a detection result from the driving wheel speed sensor 3. The idling condition is a condition related to the traction control.

The idling condition is a condition indicating whether the driving wheels are slipping in relation to the traction control. The idling condition can be calculated by a known method based on the driving wheel speeds detected by the driving wheel speed sensor 3. When the idling condition is satisfied, the driving wheels are slipping. When the idling condition is not satisfied, the driving wheels are not slipping.

When the idling condition is satisfied and the rolling wheel speeds of the undriven rolling wheels are equal to or lower than a predetermined rolling wheel speed threshold, there is a high possibility that only the driving wheels are idling with the vehicle 100 almost stopped. The rolling wheel speed threshold is a threshold for the rolling wheel speed for determining that the vehicle 100 cannot start and the vehicle speed is hardly increased. The rolling wheel speed threshold may be a preset threshold. For example, in a situation in which the vehicle 100 is stuck on a snowy road and only the driving wheels are idling to cause difficultly in the start, there is a high possibility that the right and left driving wheels are idling to the same extent. Particularly when the vehicle 100 is stuck during heavy snow, the vehicle 100 may easily start by causing the right and left driving wheels to slip to some extent to blow off snow blocks, rather than trying to start without causing the slip of the driving wheels.

Therefore, when the idling condition is satisfied, the rolling wheel speeds are equal to or lower than the predetermined rolling wheel speed threshold, and the accelerator operation amount is equal to or larger than a predetermined operation amount threshold, the proposal determination unit 23 may determine to propose the first operation for the traction control to the occupant. The operation amount threshold is a threshold of the accelerator operation amount for determining that the vehicle is trying to start. The operation amount threshold may be a preset threshold. When the right-and-left ratio of the driving wheel speeds is equal to or lower than a predetermined right-and-left ratio threshold, the proposal determination unit 23 may determine to propose the first operation for the traction control to the occupant. The right-and-left ratio threshold is a threshold of the right-and-left ratio of the driving wheel speeds for discriminating between one-wheel idling and two-wheel idling when the vehicle is trying to start. The right-and-left ratio threshold may be a preset threshold. By proposing the first operation to the occupant in the situation described above, the occupant can be prompted to switch the execution of the traction control to forbiddance depending on the situation of the vehicle 100 to facilitate the start of the vehicle 100.

When the right-and-left ratio of the driving wheel speeds is higher than the predetermined right-and-left ratio threshold, the proposal determination unit 23 may determine not to propose the first operation to the occupant. When the idling condition is satisfied and the rolling wheel speeds are higher than the predetermined rolling wheel speed threshold, only one of the right and left driving wheels is idling with the vehicle 100 almost stopped. For example, in a situation in which only one of the right and left driving wheels of the vehicle 100 is idling to cause difficultly in the start, the vehicle 100 may easily start by suppressing the slip of the one idling driving wheel through the execution of the traction control because the driving force is distributed to the other non-idling driving wheel. This operation is effective when the traction control includes control for suppressing the idling of the driving wheels by using a brake.

In a case where the permission status of the brake hold as another example of the first control is automatically set to permission when the vehicle 100 is powered ON, the proposal determination unit 23 may determine whether to propose, to the occupant, the first operation for forbidding the execution of the brake hold.

The proposal determination unit 23 may determine to propose the first operation for the brake hold to the occupant, for example, when a brake hold condition is satisfied based on at least a detection result from the accelerator sensor 8. The brake hold condition is a condition related to the brake hold.

The brake hold condition is a condition of whether to hold the brake to keep the vehicle stopped with the brake pedal released. The brake hold condition can be calculated by a known method based on detection results from the driving wheel speed sensor 3, the rolling wheel speed sensor 4, and the accelerator sensor 8. When the brake hold condition is satisfied, the stop of the vehicle 100 is kept with the brake pedal released, and can be kept even if an accelerator operation is performed in a certain amount or less. When the brake hold condition is not satisfied, the stop of the vehicle cannot be kept with the brake pedal released, and the vehicle 100 can be accelerated depending on the accelerator operation amount.

The brake hold condition is not satisfied, for example, when the accelerator operation amount increases to the certain operation amount or more in the case where the brake hold condition is satisfied. For example, when the vehicle 100 stopped on a flat ground moves backward, the keeping of the vehicle stop may be terminated when the accelerator operation amount increases to the certain operation amount or more. In this case, the adjustment of the vehicle speed may be affected to cause difficulty in slow entry into a garage.

Therefore, when the brake hold condition is satisfied and the shift position is reverse, the proposal determination unit 23 may determine to propose the first operation for the brake hold to the occupant. In the situation described above, the occupant can be prompted to switch the execution of the brake hold to forbiddance depending on the situation of the vehicle 100 to facilitate the operation of moving the vehicle 100 backward.

When a predetermined period has elapsed since the execution of the target control was forbidden in response to the first operation, the proposal determination unit 23 may determine to propose the second operation to the occupant.

The second operation is an operation to be performed by the occupant to permit the execution of the target control in which the permission status indicates forbiddance. As a specific example, the second operation includes an operation in which, when the permission status of the traction control indicates forbiddance, the occupant changes the switch status of the TRC switch 1 from OFF to ON in order to permit the execution of the traction control.

In the vehicle 100, the traction control is the first control in which the permission status is automatically set to permission when the vehicle 100 is powered ON. For example, when the occupant has forbidden the execution of the traction control in response to the first operation in a situation in which the vehicle is stuck on a snowy road and then this situation is resolved, the vehicle 100 comes into a normal state by returning the execution of the traction control to permission.

For example, based on a result of comparison between a first time threshold and an elapsed period after the execution of the traction control has been forbidden by the first operation (TRC forbiddance period), the proposal determination unit 23 may determine to propose, to the occupant, the second operation for permitting the execution of the traction control when the TRC forbiddance period is equal to or longer than the first time threshold (predetermined period). The first time threshold is a threshold of the TRC forbiddance period for determining whether to prompt the occupant to return the execution of the traction control to permission. The first time threshold may be, for example, preset seconds or stored in the brake ECU 20.

For example, based on a result of comparison between a second time threshold and an elapsed period after the idling condition is not satisfied (idling condition non-satisfaction period), the proposal determination unit 23 may determine to propose, to the occupant, the second operation for permitting the execution of the traction control when the idling condition non-satisfaction period is equal to or longer than the second time threshold (predetermined period). The second time threshold is a threshold of the idling condition non-satisfaction period for determining whether to prompt the occupant to return the execution of the traction control to permission. The second time threshold may be, for example, preset seconds or stored in the brake ECU 20.

For example, when the vehicle 100 performs sports driving, there is a possibility that the occupant voluntarily forbids the execution of the traction control regardless of whether first information described later is displayed. In general, the vehicle 100 is in the normal state when the execution of the traction control is returned to permission by prompting the occupant to perform the second operation. In such a case, the occupant need not be prompted to perform the first operation temporarily.

Therefore, the proposal determination unit 23 may determine to propose, to the occupant, the second operation for permitting the execution of the traction control, for example, when a stop of notification during the trip is not set. The stop of notification means such a setting that notification of second information on the traction control will be stopped onward during the trip. The notification stop setting status may be reset (initialized) to “stop of notification: OFF” when the vehicle 100 is powered ON. The notification stop setting status may be changed to “stop of notification: ON” by, for example, an operation of the occupant via the HMI 7. The notification stop setting status may be stored in the brake ECU 20. The proposal determination unit 23 can acquire the notification stop setting status, for example, based on a setting history of the stop of notification during the trip that is stored in the brake ECU 20.

The proposal determination unit 23 may determine to propose, to the occupant, the second operation for permitting the execution of the traction control when determination is made that the vehicle 100 is stopped based on a known predetermined condition for limiting the display on the display 7a during traveling.

The display control unit 24 controls the display 7a of the HMI 7 provided in the vehicle 100. When the proposal determination unit 23 determines to propose the first operation to the occupant, the display control unit 24 causes the display 7a to display the first information related to the first operation. Alternatively, when the proposal determination unit 23 determines to propose the second operation to the occupant, the display control unit 24 causes the display 7a to display the second information related to the second operation. The display control unit 24 presents information to the occupant of the vehicle 100, for example, by transmitting a control signal to the display 7a.

For example, when determination is made to propose the first operation for the traction control to the occupant, the display control unit 24 causes the display 7a to display the first information on the traction control. The first information is presented to the occupant in order to prompt the occupant to perform the first operation. The first information is, for example, image information to be displayed on the display 7a. As the first information, voice or sound information may be used in combination.

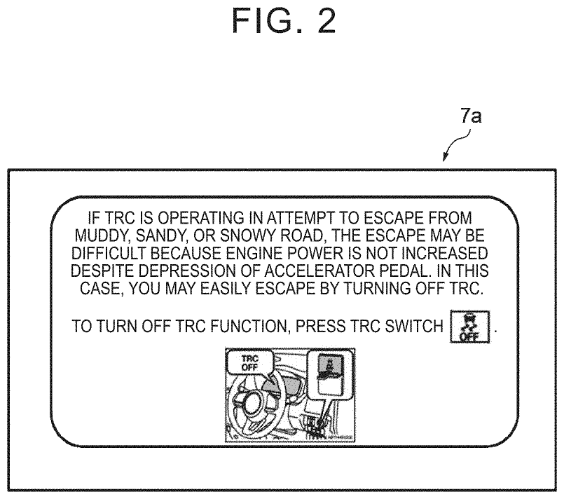

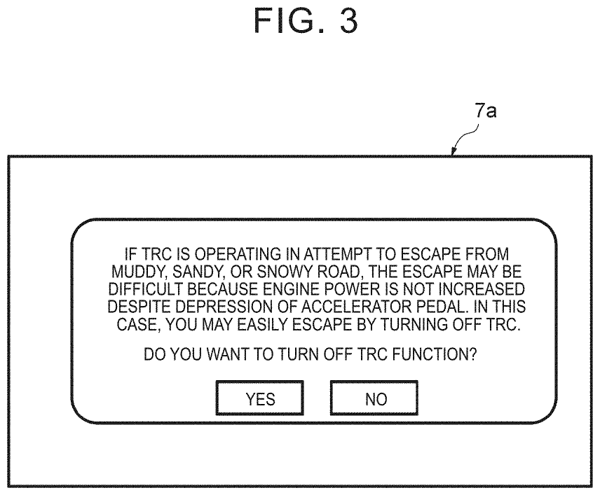

Examples of FIGS. 2 and 3 can be given as the first information on the traction control. In FIG. 2, an arrangement position of the TRC switch 1 as hardware together with text information about the first operation is shown as the first information. The occupant can recognize that the first operation using the TRC switch 1 can be taken as an option based on the first information in FIG. 2. In FIG. 3, button images of “Yes” and “No” that function as the TRC switch 1 as software together with the text information about the first operation are shown as the first information. The occupant can recognize that the first operation using the button images can be taken as an option based on the first information in FIG. 3.

When determination is made to propose the first operation for the brake hold to the occupant, the display control unit 24 may cause the display 7a to display the first information on the brake hold.

For example, image information analogous to those in FIGS. 2 and 3 can be used as the first information on the brake hold. An arrangement position of the BH switch 2 as hardware together with text information about the first operation may be shown as the first information on the brake hold. Button images of “Yes” and “No” that function as the BH switch 2 as software together with the text information about the first operation may be shown as the first information on the brake hold.

When determination is made to propose the second operation for the traction control to the occupant, the display control unit 24 may cause the display 7a to display the second information on the traction control. The second information is presented to the occupant in order to prompt the occupant to perform the second operation. The second information is, for example, image information to be displayed on the display 7a. As the second information, voice or sound information may be used in combination.

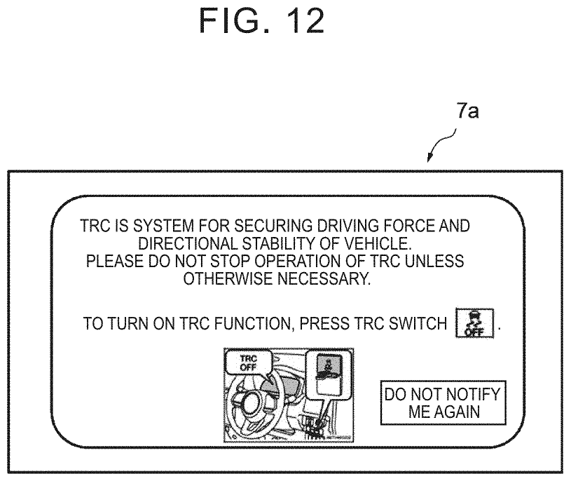

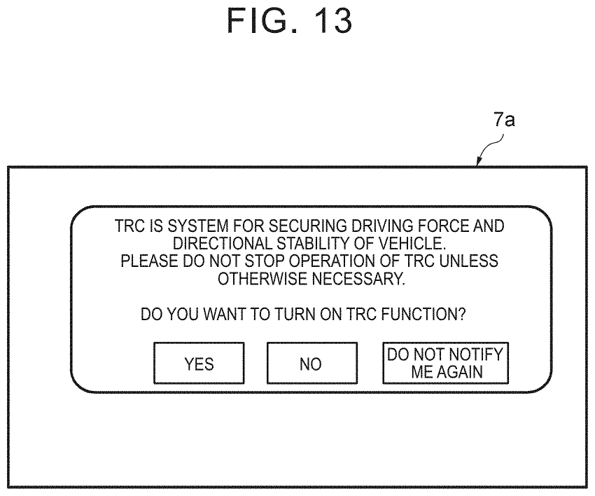

Examples of FIGS. 12 and 13 can be given as the second information on the traction control. In FIG. 12, the arrangement position of the TRC switch 1 as hardware together with text information about the second operation is shown as the second information. In FIG. 12 or 13, the first information for changing the switch status of the TRC switch 1 from ON to OFF is replaced with the content of the second information for changing the switch status of the TRC switch 1 from OFF to ON as compared with FIG. 2 or 3. The occupant can recognize that the second operation using the TRC switch 1 can be taken as an option based on the second information in FIG. 12. In FIG. 13, button images of “Yes” and “No” that function as the TRC switch 1 as software together with the text information about the second operation are shown as the second information. The occupant can recognize that the second operation using the button images can be taken as an option based on the second information in FIG. 13. In FIG. 12 or 13, display of a notification stop inquiry for the occupant (button image of “Do not notify me again”) is included in addition to the second information on the traction control. In response to the display of the notification stop inquiry for the occupant in FIG. 12 or 13, the occupant can recognize that an input operation for setting the stop of notification during the trip can be performed by using the button image.

Next, the functional configuration of the powertrain ECU 30 will be described. The powertrain ECU 30 includes a vehicle control unit 31. The functions of the powertrain ECU 30 may partially be performed on a server communicable with the vehicle 100.

The vehicle control unit 31 controls the traveling and braking of the vehicle 100 by controlling the actuator 9 based on a detection result from the accelerator sensor 8 and a control signal from the brake ECU 20. When the execution of the traction control is permitted, the vehicle control unit 31 may reduce the driving force from the drive actuator by a known method. When the execution of the traction control is permitted, the vehicle control unit 31 may brake the driving wheels or the rolling wheels by operating the brake actuator by a known method based on a control signal from the brake ECU 20.

### Examples of Arithmetic Processing by Brake ECU 20

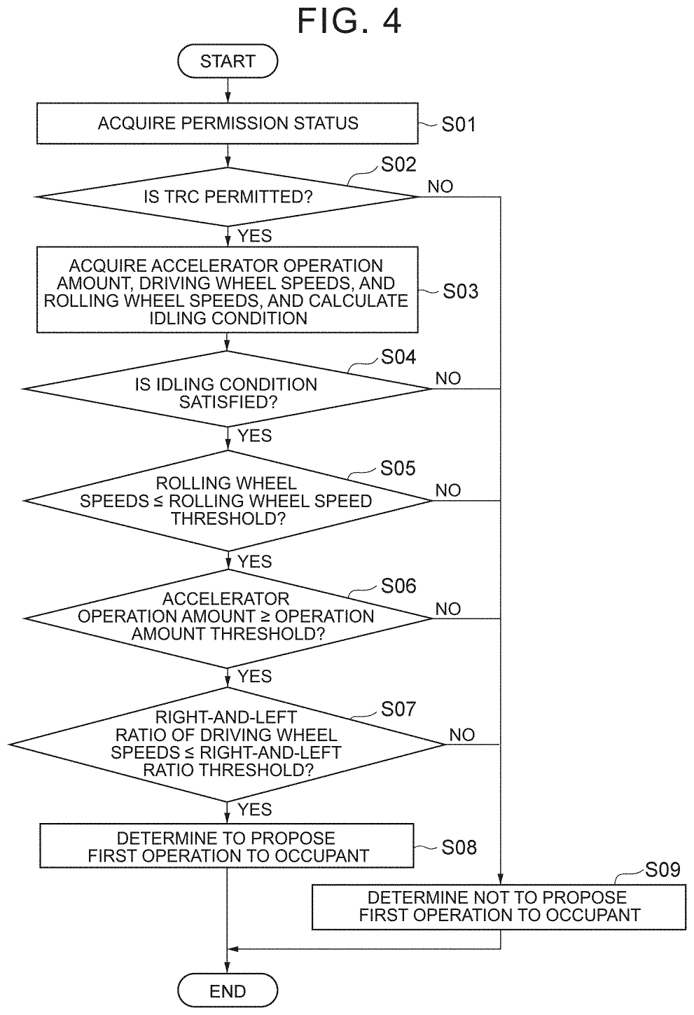

Next, examples of arithmetic processing by the brake ECU 20 will be described. Each step (process) exemplified in FIGS. 4 to 11 constitutes a display control method according to the embodiment.

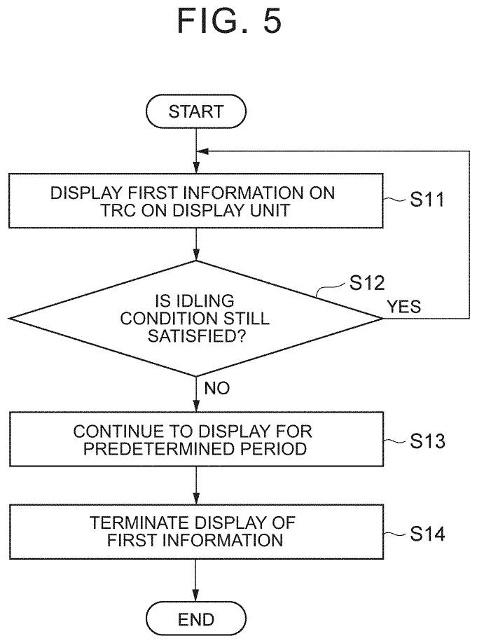

As a first example, FIG. 4 is a flowchart showing an example of a proposal determination process for the first operation. FIG. 5 is a flowchart showing an example of a display control process for the first information. The processes shown in FIGS. 4 and 5 are repeated at a predetermined cycle, for example, in a state in which the permission status of the traction control indicates permission. The processes shown in FIGS. 4 and 5 may be performed in a state in which the permission status of the traction control indicates forbiddance.

First, as shown in FIG. 4, the brake ECU 20 causes the permission status acquisition unit 21 to acquire the permission status in Step S01. The permission status acquisition unit 21 acquires, for example, the permission status of the traction control based on the switch status of the TRC switch 1. The permission status acquisition unit 21 may acquire the permission status of the traction control based on a permission status stored in the brake ECU 20.

In Step S02, the brake ECU 20 causes the proposal determination unit 23 to determine whether the traction control is permitted. The proposal determination unit 23 determines whether the traction control is permitted, for example, based on the acquired current permission status. When the proposal determination unit 23 determines that the traction control is permitted (Step S02: YES), the brake ECU 20 proceeds to Step S03.

In Step S03, the brake ECU 20 causes the proposal determination unit 23 to acquire an accelerator operation amount, driving wheel speeds, and rolling wheel speeds. The proposal determination unit 23 acquires the accelerator operation amount, the driving wheel speeds, and the rolling wheel speeds, for example, based on recognition results from the vehicle condition recognition unit 22 (detection results from the accelerator sensor 8, the driving wheel speed sensor 3, and the rolling wheel speed sensor 4). In Step S03, the brake ECU 20 causes the proposal determination unit 23 to calculate an idling condition. The proposal determination unit 23 calculates, for example, driving wheel speeds of the driving wheels and an estimated vehicle body speed for use in determination about the idling condition based on at least the detection result from the driving wheel speed sensor 3.

In Step S04, the brake ECU 20 causes the proposal determination unit 23 to determine whether the idling condition is satisfied. The proposal determination unit 23 determines whether the idling condition is satisfied, for example, based on a result of comparison between the driving wheel speeds of the driving wheels and the estimated vehicle body speed. When the proposal determination unit 23 determines that the idling condition is satisfied (Step S04: YES), the brake ECU 20 proceeds to Step S05.

In Step S05, the brake ECU 20 causes the proposal determination unit 23 to determine whether the rolling wheel speeds are equal to or lower than the rolling wheel speed threshold. The proposal determination unit 23 determines whether the rolling wheel speeds are equal to or lower than the rolling wheel speed threshold, for example, based on a result of comparison between the acquired rolling wheel speeds and the preset rolling wheel speed threshold. When the proposal determination unit 23 determines that the rolling wheel speeds are equal to or lower than the rolling wheel speed threshold (Step S05: YES), the brake ECU 20 proceeds to Step S06.

In Step S06, the brake ECU 20 causes the proposal determination unit 23 to determine whether the accelerator operation amount is equal to or larger than the operation amount threshold. The proposal determination unit 23 determines whether the accelerator operation amount is equal to or larger than the operation amount threshold, for example, based on a result of comparison between the acquired accelerator operation amount and the preset operation amount threshold. When the proposal determination unit 23 determines that the accelerator operation amount is equal to or larger than the operation amount threshold (Step S06: YES), the brake ECU 20 proceeds to Step S07.

In Step S07, the brake ECU 20 causes the proposal determination unit 23 to determine whether the right-and-left ratio of the driving wheel speeds is equal to or lower than the right-and-left ratio threshold. The proposal determination unit 23 determines whether the right-and-left ratio of the driving wheel speeds is equal to or lower than the right-and-left ratio threshold, for example, based on a result of comparison between a right-and-left ratio of the driving wheel speeds that is calculated from the right and left driving wheel speeds and the preset right-and-left ratio threshold. When the proposal determination unit 23 determines that the right-and-left ratio of the driving wheel speeds is equal to or lower than the right-and-left ratio threshold (Step S07:YES), the brake ECU 20 proceeds to Step S08. In Step S08, the brake ECU 20 causes the proposal determination unit 23 to determine to propose the first operation for the traction control to the occupant. Then, the brake ECU 20 terminates the process of FIG. 4 and proceeds to the process of FIG. 5.

When the proposal determination unit 23 determines that the traction control is not permitted (Step S02: NO), the idling condition is not satisfied (Step S04: NO), the rolling wheel speeds are not equal to or lower than the rolling wheel speed threshold (Step S05: NO), the accelerator operation amount is not equal to or larger than the operation amount threshold (Step S06: NO), or the right-and-left ratio of the driving wheel speeds is not equal to or lower than the right-and-left ratio threshold (Step S07:NO), the brake ECU 20 proceeds to Step S09. In Step S09, the brake ECU 20 causes the proposal determination unit 23 to determine not to propose the first operation for the traction control to the occupant. Then, the brake ECU 20 terminates the process of FIG. 4.

Subsequently, as shown in FIG. 5, the brake ECU 20 causes the display control unit 24 to display the first information on the traction control on the display unit in Step S11. The display control unit 24 causes the display 7a to display, for example, the image of FIG. 2 or FIG. 3.

In Step S12, the brake ECU 20 causes the display control unit 24 to determine whether the idling condition is still satisfied. The display control unit 24 determines whether the idling condition is still satisfied, for example, based on an idling condition calculated in the same manner as in the process of Step S03 of FIG. 4. When the display control unit 24 determines that the idling condition is still satisfied (Step S12: YES), the brake ECU 20 repeats the process of Step S11.

When the display control unit 24 determines that the idling condition is no longer satisfied (Step S12: NO), the brake ECU 20 causes the display control unit 24 to continue to display the first information on the traction control for the predetermined period in Step S13. For example, the display control unit 24 causes the display 7a to keep displaying the image of FIG. 2 or 3 until the predetermined period elapses after the idling condition is no longer satisfied, thereby suppressing oversight by the occupant.

In Step S14, the brake ECU 20 causes the display control unit 24 to terminate the display of the first information on the traction control. Then, the brake ECU 20 terminates the process of FIG. 5.

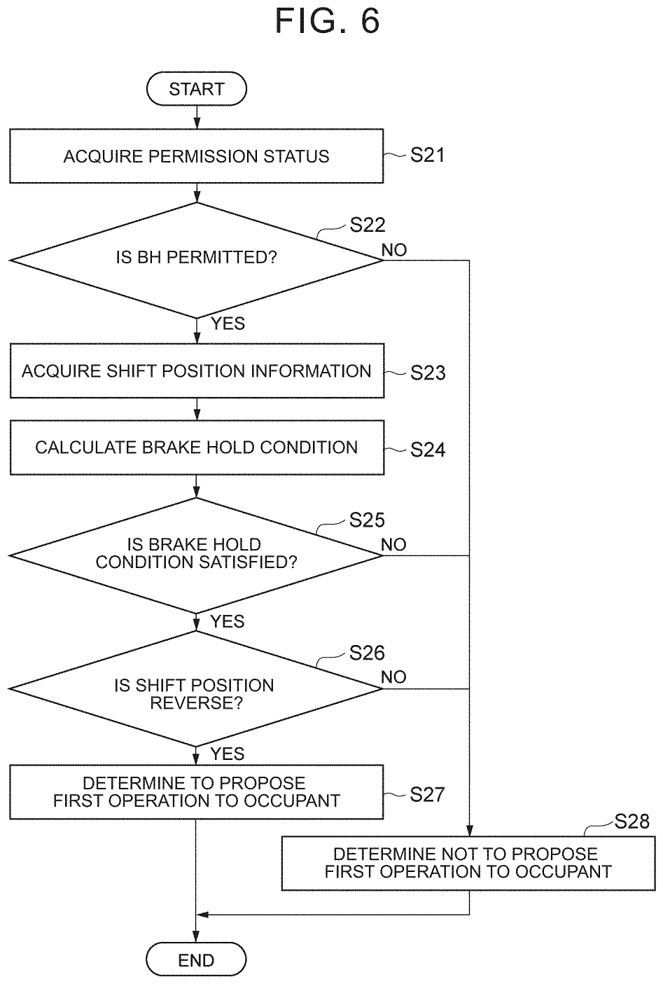

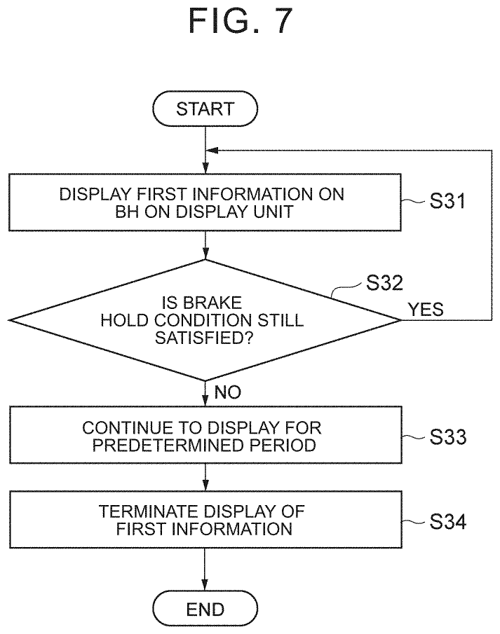

As a second example, FIG. 6 is a flowchart showing another example of the proposal determination process for the first operation. FIG. 7 is a flowchart showing another example of the display control process for the first information. The processes shown in FIGS. 6 and 7 are repeated at a predetermined cycle, for example, in a state in which the permission status of the brake hold indicates permission. The processes shown in FIGS. 6 and 7 may be performed in a state in which the permission status of the brake hold indicates forbiddance.

First, as shown in FIG. 6, the brake ECU 20 causes the permission status acquisition unit 21 to acquire the permission status in Step S21. The permission status acquisition unit 21 acquires, for example, the permission status of the brake hold based on the switch status of the BH switch 2. The permission status acquisition unit 21 may acquire the permission status of the brake hold based on a permission status stored in the brake ECU 20.

In Step S22, the brake ECU 20 causes the proposal determination unit 23 to determine whether the brake hold is permitted. The proposal determination unit 23 determines whether the brake hold is permitted, for example, based on the acquired current permission status. When the proposal determination unit 23 determines that the brake hold is permitted (Step S22: YES), the brake ECU 20 proceeds to Step S23.

In Step S23, the brake ECU 20 causes the vehicle condition recognition unit 22 to acquire shift position information. The vehicle condition recognition unit 22 acquires the shift position information, for example, based on a detection result from the reverse switch 5. In Step S24, the brake ECU 20 causes the proposal determination unit 23 to calculate a brake hold condition. The proposal determination unit 23 calculates the brake hold condition, for example, based on detection results from the driving wheel speed sensor 3, the rolling wheel speed sensor 4, and the accelerator sensor 8.

In Step S25, the brake ECU 20 causes the proposal determination unit 23 to determine whether the brake hold condition is satisfied. The proposal determination unit 23 determines whether the brake hold condition is satisfied, for example, based on an accelerator operation amount. When the proposal determination unit 23 determines that the brake hold condition is satisfied (Step S25: YES), the brake ECU 20 proceeds to Step S26.

In Step S26, the brake ECU 20 causes the proposal determination unit 23 to determine whether the shift position is reverse. The proposal determination unit 23 determines whether the shift position is reverse, for example, based on the acquired shift position information. When the proposal determination unit 23 determines that the shift position is reverse (Step S26: YES), the brake ECU 20 proceeds to Step S27. In Step S27, the brake ECU 20 causes the proposal determination unit 23 to determine to propose the first operation for the brake hold to the occupant. Then, the brake ECU 20 terminates the process of FIG. 6 and proceeds to the process of FIG. 7.

When the proposal determination unit 23 determines that the brake hold is not permitted (Step S22: NO), the brake hold condition is not satisfied (Step S25: NO), or the shift position is not reverse (Step S26: NO), the brake ECU 20 proceeds to Step S28. In Step S28, the brake ECU 20 causes the proposal determination unit 23 to determine not to propose the first operation for the brake hold to the occupant. Then, the brake ECU 20 terminates the process of FIG. 6.

Subsequently, as shown in FIG. 7, the brake ECU 20 causes the display control unit 24 to display the first information on the brake hold on the display unit in Step S31. The display control unit 24 causes the display 7a to display, for example, an image analogous to that in FIG. 2 or FIG. 3 in which the operation target and the explanatory text are replaced with those for the BH switch 2.

In Step S32, the brake ECU 20 causes the display control unit 24 to determine whether the brake hold condition is still satisfied. The display control unit 24 determines whether the brake hold condition is still satisfied, for example, based on a brake hold condition calculated in the same manner as in the process of Step S24 of FIG. 6. When the display control unit 24 determines that the brake hold condition is still satisfied (Step S32: YES), the brake ECU 20 repeats the process of Step S31.

When the display control unit 24 determines that the brake hold condition is no longer satisfied (Step S32: NO), the brake ECU 20 causes the display control unit 24 to continue to display the first information on the brake hold for the predetermined period in Step S33. For example, the display control unit 24 causes the display 7a to keep displaying the image analogous to that in FIG. 2 or 3 in which the operation target and the explanatory text are replaced with those for the BH switch 2 until the predetermined period elapses after the brake hold condition is no longer satisfied, thereby suppressing oversight by the occupant.

In Step S34, the brake ECU 20 causes the display control unit 24 to terminate the display of the first information on the brake hold. Then, the brake ECU 20 terminates the process of FIG. 7.

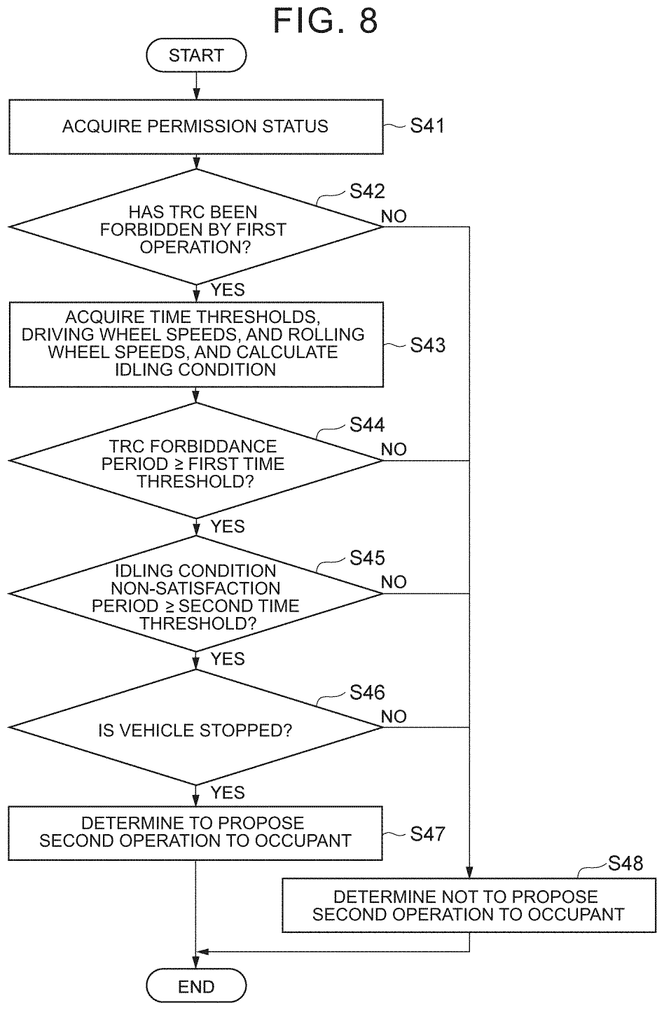

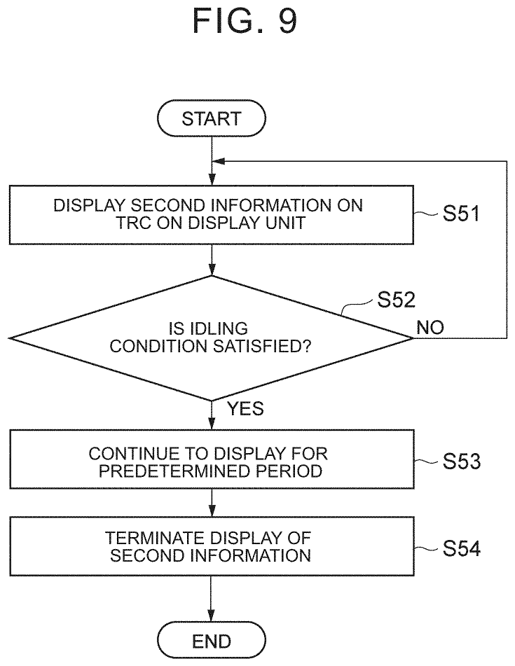

As a third example, FIG. 8 is a flowchart showing an example of a proposal determination process for the second operation. FIG. 9 is a flowchart showing an example of a display control process for the second information. The processes shown in FIGS. 8 and 9 are repeated at a predetermined cycle, for example, in a state in which the occupant has set the permission status of the traction control to forbiddance in response to the display of the first information in FIG. 5. The processes shown in FIGS. 8 and 9 may be performed in a state in which the occupant has voluntarily set the permission status of the traction control to forbiddance regardless of the display of the first information in FIG. 5, or in a state in which the permission status of the traction control indicates permission.

First, as shown in FIG. 8, the brake ECU 20 causes the permission status acquisition unit 21 to acquire the permission status in Step S41 in the same manner as in Step S01 of FIG. 4.

In Step S42, the brake ECU 20 causes the proposal determination unit 23 to determine whether the traction control has been forbidden by the first operation. The proposal determination unit 23 determines whether the traction control has been forbidden by the first operation, for example, based on a history of the display of the first information in FIG. 5 and the current permission status. When the proposal determination unit 23 determines that the traction control has been forbidden by the first operation as in a case where the traction control has been forbidden by the first operation of the occupant, for example, based on the first information displayed through the processes of FIGS. 4 and 5 (Step S42: YES), the brake ECU 20 proceeds to Step S43.

In Step S43, the brake ECU 20 causes the proposal determination unit 23 to acquire time thresholds, driving wheel speeds, and rolling wheel speeds. The proposal determination unit 23 acquires the first time threshold, the second time threshold, the driving wheel speeds, and the rolling wheel speeds, for example, based on prestored time thresholds and recognition results from the vehicle condition recognition unit 22 (detection results from the driving wheel speed sensor 3 and the rolling wheel speed sensor 4). In Step S43, the brake ECU 20 causes the proposal determination unit 23 to calculate an idling condition. The proposal determination unit 23 calculates the idling condition, for example, based on at least the detection result from the driving wheel speed sensor 3.

In Step S44, the brake ECU 20 causes the proposal determination unit 23 to determine whether the traction control forbiddance period is equal to or longer than the first time threshold. The proposal determination unit 23 determines whether the traction control forbiddance period is equal to or longer than the first time threshold, for example, based on a result of comparison between the first time threshold and an elapsed period after the traction control has been forbidden. When the proposal determination unit 23 determines that the traction control forbiddance period is equal to or longer than the first time threshold (Step S44: YES), the brake ECU 20 proceeds to Step S45.

In Step S45, the brake ECU 20 causes the proposal determination unit 23 to determine whether the idling condition non-satisfaction period is equal to or longer than the second time threshold. The proposal determination unit 23 determines whether the idling condition non-satisfaction period is equal to or longer than the second time threshold, for example, based on a result of comparison between the second time threshold and an elapsed period after the idling condition is not satisfied. When the proposal determination unit 23 determines that the idling condition non-satisfaction period is equal to or longer than the second time threshold (Step S45: YES), the brake ECU 20 proceeds to Step S46.

In Step S46, the brake ECU 20 causes the proposal determination unit 23 to determine whether the vehicle 100 is stopped. The proposal determination unit 23 determines whether the vehicle 100 is stopped, for example, based on a known predetermined condition for limiting the display on the display 7a during traveling. When the proposal determination unit 23 determines that the vehicle 100 is stopped (Step S46: YES), the brake ECU 20 proceeds to Step S47.

In Step S47, the brake ECU 20 causes the proposal determination unit 23 to determine to propose the second operation for the traction control to the occupant. Then, the brake ECU 20 terminates the process of FIG. 8 and proceeds to the process of FIG. 9.

When the proposal determination unit 23 determines that the traction control has not been forbidden by the first operation (Step S42: NO), the traction control forbiddance period is not equal to or longer than the first time threshold (Step S44: NO), the idling condition non-satisfaction period is not equal to or longer than the second time threshold (Step S45: NO), or the vehicle 100 is not stopped (Step S46: NO), the brake ECU 20 proceeds to Step S48. In Step S48, the brake ECU 20 causes the proposal determination unit 23 to determine not to propose the second operation for the traction control to the occupant. Then, the brake ECU 20 terminates the process of FIG. 8.

Subsequently, as shown in FIG. 9, the brake ECU 20 causes the display control unit 24 to display the second information on the traction control on the display unit in Step S51. The display control unit 24 causes the display 7a to display, for example, the image of FIG. 12 or FIG. 13. In the process of FIG. 9, the “Do not notify me again” button in the image of FIG. 12 or FIG. 13 need not be displayed.

In Step S52, the brake ECU 20 causes the display control unit 24 to determine whether the idling condition is satisfied. The display control unit 24 determines whether the idling condition is satisfied, for example, based on an idling condition calculated in the same manner as in the process of Step S43 of FIG. 8. When the display control unit 24 determines that the idling condition is not satisfied (the idling condition is still unsatisfied) (Step S52: NO), the brake ECU 20 repeats the process of Step S51.

When the display control unit 24 determines that the idling condition is satisfied (Step S52: YES), the brake ECU 20 causes the display control unit 24 to continue to display the second information on the traction control for the predetermined period in Step S53. For example, the display control unit 24 causes the display 7a to keep displaying the image of FIG. 12 or 13 until the predetermined period elapses after the idling condition is satisfied, thereby suppressing oversight by the occupant.

In Step S54, the brake ECU 20 causes the display control unit 24 to terminate the display of the second information on the traction control. Then, the brake ECU 20 terminates the process of FIG. 9.

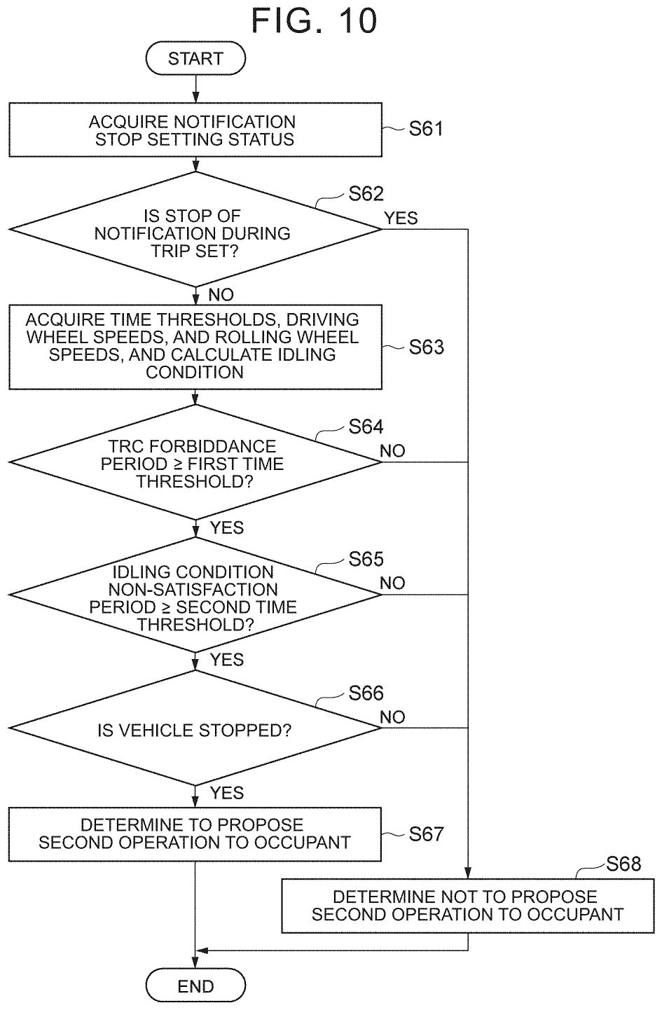

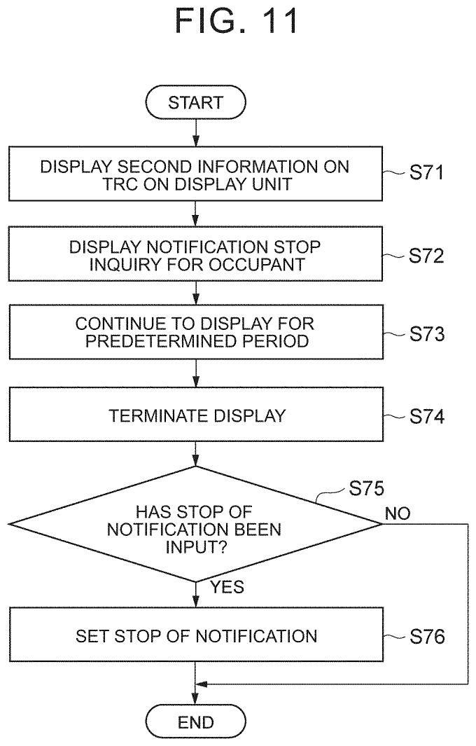

As a fourth example, FIG. 10 is a flowchart showing another example of the proposal determination process for the second operation. FIG. 11 is a flowchart showing another example of the display control process for the second information. The processes shown in FIGS. 10 and 11 are repeated at a predetermined cycle, for example, in a state in which the occupant has voluntarily set the permission status of the traction control to forbiddance regardless of whether the first information is displayed in FIG. 5.

First, as shown in FIG. 10, the brake ECU 20 causes the proposal determination unit 23 to acquire a notification stop setting status in Step S61. The proposal determination unit 23 acquires the notification stop setting status, for example, based on a setting history of the stop of notification during the trip that is stored in the brake ECU 20.

In Step S62, the brake ECU 20 causes the proposal determination unit 23 to determine whether the stop of notification during the trip is set. The proposal determination unit 23 determines whether the stop of notification during the trip is set, for example, based on the acquired current notification stop setting status. When the proposal determination unit 23 determines that the stop of notification during the trip is not set as in a case where the occupant has not input the stop of notification, for example, in response to a notification stop inquiry displayed through the process of FIG. 11 described later (Step S62: NO), the brake ECU 20 proceeds to Step S63.

In Step S63, the brake ECU 20 causes the proposal determination unit 23 to acquire time thresholds, driving wheel speeds, and rolling wheel speeds in the same manner as in, for example, Step S43 of FIG. 8. In Step S63, the brake ECU 20 causes the proposal determination unit 23 to calculate an idling condition in the same manner as in, for example, Step S43 of FIG. 8.

In Step S64, the brake ECU 20 causes the proposal determination unit 23 to determine whether the traction control forbiddance period is equal to or longer than the first time threshold in the same manner as in, for example, Step S44 of FIG. 8. When the proposal determination unit 23 determines that the traction control forbiddance period is equal to or longer than the first time threshold (Step S64: YES), the brake ECU 20 proceeds to Step S65.

In Step S65, the brake ECU 20 causes the proposal determination unit 23 to determine whether the idling condition non-satisfaction period is equal to or longer than the second time threshold in the same manner as in, for example, Step S45 of FIG. 8. When the proposal determination unit 23 determines that the idling condition non-satisfaction period is equal to or longer than the second time threshold (Step S65: YES), the brake ECU 20 proceeds to Step S66.

In Step S66, the brake ECU 20 causes the proposal determination unit 23 to determine whether the vehicle 100 is stopped in the same manner as in, for example, Step S46 of FIG. 8. When the proposal determination unit 23 determines that the vehicle 100 is stopped (Step S66: YES), the brake ECU 20 proceeds to Step S67.

In Step S67, the brake ECU 20 causes the proposal determination unit 23 to determine to propose the second operation for the traction control to the occupant. Then, the brake ECU 20 terminates the process of FIG. 10 and proceeds to the process of FIG. 11.

When the proposal determination unit 23 determines that the stop of notification during the trip is set (Step S62: YES), the traction control forbiddance period is not equal to or longer than the first time threshold (Step S64: NO), the idling condition non-satisfaction period is not equal to or longer than the second time threshold (Step S65: NO), or the vehicle 100 is not stopped (Step S66: NO), the brake ECU 20 causes the proposal determination unit 23 to determine not to propose the second operation for the traction control to the occupant in Step S68. Then, the brake ECU 20 terminates the process of FIG. 10.

Subsequently, as shown in FIG. 11, the brake ECU 20 causes the display control unit 24 to display the second information on the traction control on the display 7a in Step S71. The display control unit 24 causes the display 7a to display, for example, the image of FIG. 12 or FIG. 13.

In Step S72, the brake ECU 20 causes the display control unit 24 to display a notification stop inquiry for the occupant on the display 7a. The display control unit 24 causes the display 7a to display, for example, the image of FIG. 12 or FIG. 13. The image of FIG. 12 or FIG. 13 includes both the second information on the traction control and the notification stop inquiry for the occupant.

In Step S73, the brake ECU 20 causes the display control unit 24 to continue to display the second information on the traction control and the notification stop inquiry for the occupant for a predetermined period. For example, the display control unit 24 causes the display 7a to keep displaying the image of FIG. 12 or 13, thereby suppressing oversight by the occupant.

In Step S74, the brake ECU 20 causes the display control unit 24 to terminate the display of the second information on the traction control and the notification stop inquiry for the occupant.

In Step S75, the brake ECU 20 causes the display control unit 24 to determine whether the stop of notification has been input. The display control unit 24 determines whether the stop of notification has been input by the occupant, for example, based on whether an input operation has been made on the “Do not notify me again” button in the image of FIG. 12 or FIG. 13 displayed through the process of Step S72. When the display control unit 24 determines that the stop of notification has been input (Step S75: YES), the brake ECU 20 proceeds to Step S76.

In Step S76, the brake ECU 20 causes the proposal determination unit 23 to set the stop of notification. The proposal determination unit 23 sets the stop of notification, for example, by storing, in the brake ECU 20, a setting history indicating that the notification of the second information on the traction control will not be given onward during the trip. Then, the brake ECU 20 terminates the process of FIG. 11. The brake ECU 20 may reset the setting history of the stop of notification to “stop of notification: OFF” when the vehicle 100 is powered ON next time.

When the display control unit 24 determines that the stop of notification has not been input (Step S75: NO), the brake ECU 20 terminates the process of FIG. 11. The brake ECU 20 may determine whether the stop of notification is input in Step S75 after the notification stop inquiry has been displayed for the occupant in Step S72. In this case, when the stop of notification has been input by the occupant (Step S75: YES), the display may be terminated (Step S74) without continuing to display the second information on the traction control and the notification stop inquiry for the occupant for the predetermined period (Step S73).

Display Control Program

A display control program causes the brake ECU 20 of the vehicle 100 to function (operate) as the permission status acquisition unit 21, the vehicle condition recognition unit 22, the proposal determination unit 23, and the display control unit 24. The display control program is provided by a non-transitory recording medium such as a ROM or a semiconductor memory. The display control program may also be provided by communication via a network or the like.

With the display control device 10 described above (vehicle display device 50, vehicle 100, display control method, and display control program), determination is made as to whether to propose, to the occupant, the first operation for forbidding the execution of the target control (traction control or brake hold) in which the permission status indicates permission based on the permission status indicating permission or forbiddance of the execution of the target control and the conditions of the vehicle 100. When determination is made to propose the first operation to the occupant, the first information related to the first operation is displayed on the display 7a of the HMI 7. Alternatively, determination is made as to whether to propose, to the occupant, the second operation for permitting the execution of the target control in which the permission status indicates forbiddance based on the permission status and the conditions of the vehicle 100. When determination is made to propose the second operation to the occupant, the second information related to the second operation is displayed on the display 7a. Therefore, the occupant can easily recognize the options for permission or forbiddance of the execution of the target control depending on the situation of the vehicle 100. Thus, it is possible to prompt the occupant to perform the operation of switching the permission or forbiddance of the execution of the target control depending on the situation of the vehicle 100.

The target control includes the first control (traction control and brake hold) in which the permission status is automatically set to permission when the vehicle 100 is powered ON. Determination is made as to whether to propose the first operation for the first control to the occupant. When determination is made to propose the first operation to the occupant, the first information on the first control is displayed on the display 7a. As a result, it is possible to prompt, depending on the situation of the vehicle, the occupant to perform the first operation for forbidding the execution of the first control in which the permission status is automatically set to permission when the vehicle 100 is powered ON.

When the predetermined period has elapsed since the execution of the target control was forbidden in response to the first operation, determination is made to propose the second operation to the occupant. As a result, it is possible to prompt the occupant to return the execution of the first control forbidden in response to the first operation to permission through the second operation depending on the situation of the vehicle 100.

The target control is the traction control. The internal sensor includes the driving wheel speed sensor 3 that detects the driving wheel speeds of the driving wheels. When the idling condition is satisfied based on a detection result from the driving wheel speed sensor, determination is made to propose the first operation for the traction control to the occupant. When determination is made to propose the first operation to the occupant, the first information on the traction control is displayed on the display 7a. Even if the idling condition is satisfied, there is a possibility that the execution of the traction control is not always appropriate for the situation of the vehicle 100. Therefore, it is possible to prompt the occupant to perform the first operation for forbidding the execution of the traction control depending on the situation of the vehicle 100.

The internal sensor includes the rolling wheel speed sensor 4 that detects the rolling wheel speeds of the rolling wheels, and the accelerator sensor that detects the accelerator operation amount. When the rolling wheel speeds are equal to or lower than the predetermined rolling wheel speed threshold and the accelerator operation amount is equal to or larger than the predetermined operation amount threshold, determination is made to propose the first operation for the traction control to the occupant. In this case, there is a possibility that both the right and left driving wheels easily idle in an attempt to escape from a stuck condition such as a snowy road. Therefore, it is possible to prompt the occupant to perform the first operation for forbidding the execution of the traction control depending on the situation of the vehicle 100.

The driving wheel speed sensor 3 detects the driving wheel speeds of the right and left driving wheels. When the right-and-left ratio of the driving wheel speeds is higher than the predetermined right-and-left ratio threshold, determination is made not to propose the first operation to the occupant. In this case, for example, one of the right and left driving wheels is idling, and there is a possibility that the execution of the traction control is appropriate for the situation of the vehicle 100. Therefore, it is possible to avoid, depending on the situation of the vehicle, the proposal to the occupant about the first operation for forbidding the execution of the traction control.

When the execution of the traction control is forbidden in response to the first operation and the idling condition is not satisfied continuously for the predetermined period, determination is made to propose the second operation to the occupant. For example, there is a possibility that the occupant has forbidden the execution of the traction control by a voluntary operation and then forgets to return the permission status to permit the execution of the traction control. Therefore, it is possible to prompt the occupant to return the execution of the traction control to permission through the second operation.

Modifications

Although the embodiment of the present disclosure has been described above, the present disclosure is not limited to the embodiment described above. The present disclosure can be implemented in various forms including various modifications and improvements based on the knowledge of those skilled in the art, including the embodiment described above.

In the embodiment described above, the processes of FIGS. 4 and 5, FIGS. 6 and 7, FIGS. 8 and 9, and FIGS. 10 and 11 are illustrated as the first to fourth examples, but the brake ECU 20 need not execute all the processes. The brake ECU 20 may execute at least one of the first to fourth examples. In the first to fourth examples, a part of the determination blocks (for example, at least one of Step S07, Step S13, Step S33, Step S45, Step S46, Step S53, Step S65, Step S66, and Step S73) may be omitted.

In the embodiment described above, the traction control is the first control in which the permission status is automatically set to permission when the vehicle 100 is powered ON, but the traction control is not limited to this control. The traction control may be the second control in which the permission status is automatically set to forbiddance, and the traction control may have, for example, specifications in which the settings during the previous trip are maintained also during the current trip. As the target control for the predetermined function, the details about the traction control of the embodiment described above can also be applied to an anti-skid system (electric stability control (ESC)) together with or in place of the traction control.

In the embodiment described above, the brake hold is the first control in which the permission status is automatically set to permission when the vehicle 100 is powered ON, but the brake hold is not limited to this control. The brake hold may be the second control in which the permission status is automatically set to forbiddance, and the brake hold may have, for example, specifications in which the settings during the previous trip are maintained also during the current trip.

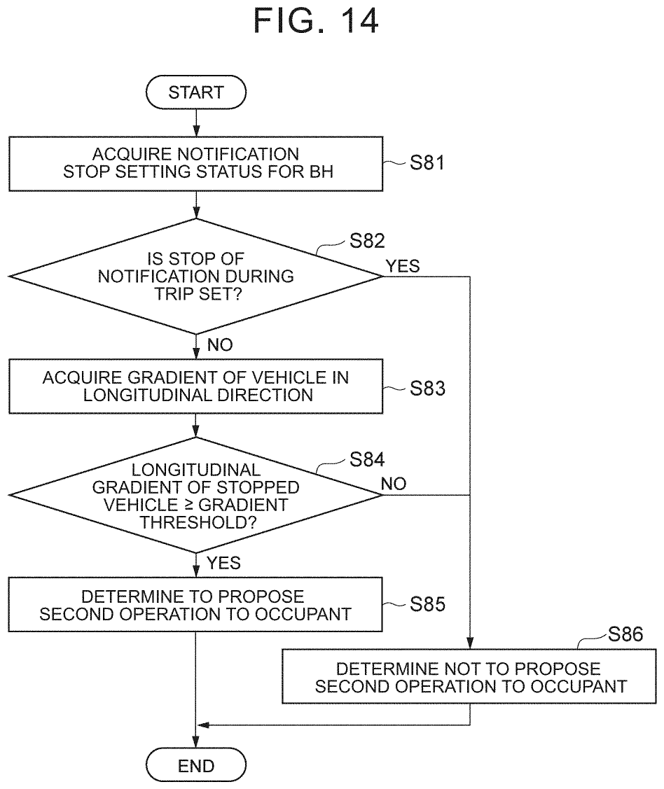

For example, when the brake hold is the second control in which the permission status is automatically set to forbiddance, the brake ECU 20 may perform a process shown in FIG. 14. FIG. 14 is a flowchart showing another example of the proposal determination process for the second operation.

First, as shown in FIG. 14, the brake ECU 20 causes the proposal determination unit 23 to acquire a notification stop setting status for the brake hold in Step S81. The proposal determination unit 23 acquires the notification stop setting status for the brake hold, for example, based on a setting history of the stop of notification during the trip that is stored in the brake ECU 20.

In Step S82, the brake ECU 20 causes the proposal determination unit 23 to determine whether the stop of notification for the brake hold during the trip is set. The proposal determination unit 23 determines whether the stop of notification for the brake hold during the trip is set, for example, based on the acquired current notification stop setting status. When the proposal determination unit 23 determines that the stop of notification during the trip is not set (Step S82: NO), the brake ECU 20 proceeds to Step S83.

In Step S83, the brake ECU 20 causes the proposal determination unit 23 to acquire a gradient of the vehicle 100 in a longitudinal direction (longitudinal gradient). The proposal determination unit 23 acquires the gradient of the vehicle 100 in the longitudinal direction, for example, based on a detection result from the acceleration sensor.

In Step S84, the brake ECU 20 causes the proposal determination unit 23 to determine whether the longitudinal gradient of the stopped vehicle 100 is equal to or larger than a gradient threshold. When the proposal determination unit 23 determines that the longitudinal gradient of the stopped vehicle 100 is equal to or larger than the gradient threshold (Step S84: YES), the brake ECU 20 proceeds to Step S85.

In Step S85, the brake ECU 20 causes the proposal determination unit 23 to determine to propose the second operation for the brake hold to the occupant. Then, the brake ECU 20 terminates the process of FIG. 14. Then, the brake ECU 20 may proceed to a process of a flowchart in which Step S71 of FIG. 11 is replaced with “display second information on brake hold on display unit”.

When the proposal determination unit 23 determines that the stop of notification for the brake hold during the trip is set (Step S82: YES) or the longitudinal gradient is not equal to or larger than the gradient threshold (Step S84: NO), the brake ECU 20 causes the proposal determination unit 23 to determine not to propose the second operation for the brake hold to the occupant in Step S86. Then, the brake ECU 20 terminates the process of FIG. 14.

As described above, with the process shown in FIG. 14, it is possible to prompt, depending on the situation of the vehicle 100, the occupant to perform the second operation for permitting the execution of the brake hold (second control) in which the permission status is automatically set to forbiddance when the vehicle 100 is powered ON, for example, in a situation in which the vehicle 100 is stopped on a slope where the longitudinal gradient is equal to or larger than the gradient threshold.

The vehicle 100 may include a drive system other than that of the FF vehicle and the FR vehicle. In the vehicle 100, all the wheels may be the driving wheels, or four-wheel drive and two-wheel drive may be switched automatically.

What is claimed is:

1. A display control device for a vehicle, comprising a processor configured to:
switch permission or forbiddance of execution of target control for a predetermined function by an operation of an occupant;
acquire a permission status indicating permission or forbiddance of the execution of the target control;
recognize a condition of the vehicle based on a detection result from an internal sensor configured to detect the condition of the vehicle;
determine whether to propose a first operation or a second operation to the occupant based on the permission status and the condition of the vehicle, the first operation being an operation for forbidding the execution of the target control in which the permission status indicates permission, the second operation being an operation for permitting the execution of the target control in which the permission status indicates forbiddance; and
display first information related to the first operation on a display unit provided in the vehicle when the processor determines to propose the first operation to the occupant, or display second information related to the second operation on the display unit when the processor determines to propose the second operation to the occupant.

2. The display control device according to claim 1, wherein:
the target control includes first control in which the permission status is automatically set to permission when the vehicle is powered ON; and
the processor is configured to
determine whether to propose the first operation for the first control to the occupant, and
display the first information on the first control on the display unit when the processor determines to propose the first operation to the occupant.

3. The display control device according to claim 1, wherein:
the target control includes second control in which the permission status is automatically set to forbiddance when the vehicle is powered ON; and
the processor is configured to
determine whether to propose the second operation for the second control to the occupant, and
display the second information on the second control on the display unit when the processor determines to propose the second operation to the occupant.

4. The display control device according to claim 2, wherein the processor is configured to determine to propose the second operation to the occupant when a predetermined period has elapsed since the execution of the target control was forbidden in response to the first operation.

5. The display control device according to claim 1, wherein:
the target control is traction control;
the internal sensor includes a driving wheel speed sensor configured to detect a driving wheel speed of a driving wheel; and
the processor is configured to
determine to propose the first operation for the traction control to the occupant when an idling condition related to the traction control is satisfied based on a detection result from the driving wheel speed sensor, and
display the first information on the traction control on the display unit when the processor determines to propose the first operation to the occupant.

6. The display control device according to claim 5, wherein:
the internal sensor includes a rolling wheel speed sensor configured to detect a rolling wheel speed of a rolling wheel, and an accelerator sensor configured to detect an accelerator operation amount; and
the processor is configured to determine to propose the first operation for the traction control to the occupant when the rolling wheel speed is equal to or lower than a predetermined rolling wheel speed threshold and the accelerator operation amount is equal to or larger than a predetermined operation amount threshold.

7. The display control device according to claim 5, wherein:
the driving wheel speed sensor is configured to detect the driving wheel speeds of the driving wheels on right and left; and
the processor is configured to determine not to propose the first operation to the occupant when a right-and-left ratio of the driving wheel speeds is higher than a predetermined right-and-left ratio threshold.

8. The display control device according to claim 5, wherein the processor is configured to determine to propose the second operation to the occupant when execution of the traction control is forbidden in response to the first operation and the idling condition is not satisfied continuously for a predetermined period.

9. A vehicle display device comprising:
the display control device according to claim 1; and
the display unit to be controlled by the display control device.

10. A vehicle comprising the vehicle display device according to claim 9.

11. A display control method for controlling a display unit provided in a vehicle, the display control method comprising:
switching permission or forbiddance of execution of target control for a predetermined function by an operation of an occupant;
acquiring a permission status indicating permission or forbiddance of the execution of the target control;
recognizing a condition of the vehicle based on a detection result from an internal sensor configured to detect the condition of the vehicle;
determining whether to propose a first operation or a second operation to the occupant based on the permission status and the condition of the vehicle, the first operation being an operation for forbidding the execution of the target control in which the permission status indicates permission, the second operation being an operation for permitting the execution of the target control in which the permission status indicates forbiddance; and
displaying first information related to the first operation on the display unit when determination is made to propose the first operation to the occupant, or displaying second information related to the second operation on the display unit when determination is made to propose the second operation to the occupant.

12. A non-transitory storage medium storing instructions that are executable by one or more processors of a display control device configured to control a display unit provided in a vehicle and that cause the one or more processors to perform functions comprising:
switching permission or forbiddance of execution of target control for a predetermined function by an operation of an occupant;
acquiring a permission status indicating permission or forbiddance of the execution of the target control;
recognizing a condition of the vehicle based on a detection result from an internal sensor configured to detect the condition of the vehicle;
determining whether to propose a first operation or a second operation to the occupant based on the permission status and the condition of the vehicle, the first operation being an operation for forbidding the execution of the target control in which the permission status indicates permission, the second operation being an operation for permitting the execution of the target control in which the permission status indicates forbiddance; and
displaying first information related to the first operation on the display unit when determination is made to propose the first operation to the occupant, or displaying second information related to the second operation on the display unit when determination is made to propose the second operation to the occupant.
